(19) United States
(12) Patent Application Publication
(10) Pub. No.: US 2026/0084142 A1
(43) Pub. Date: Mar. 26, 2026

(54) METHOD FOR THE QUALITY-ASSESSED METERING OF A METERING FLUID, AND PIPETTING DEVICE DESIGNED TO CARRY OUT THE METHOD

(71) Applicant: Hamilton Bonaduz AG, Bonaduz (CH)

(72) Inventors: Renato Nay, Masein (CH); René Ackermann, Chur (CH); Mathias Nagel, Bern (CH)

(21) Appl. No.: 19/111,863

(22) PCT Filed: Sep. 1, 2023
(86) PCT No.: PCT/EP2023/074049

§ 371 Date: Mar. 14, 2025

(30) Foreign Application Priority Data
Sep. 15, 2022 (DE) 10 2022 123 672.2

(51) Int. Cl. B01L 3/02; G01N 35/10

(52) U.S. Cl. CPC B01L 3/0227; B01L 3/0275; G01N 35/1016; B01L 2200/146; B01L 2200/148

(57) ABSTRACT

A method for the quality-assessed metering by means of a pipetting device, the method including the following steps:—carrying out a metering process by moving a pipetting plunger, —recording the time curve of the working-gas pressure in a pipetting channel during the metering process, —comparing the curve of the working-gas pressure on the basis of the recorded time curve of the working-gas pressure with a predetermined target pressure value range, and—outputting a quality assessment of the metering process on the basis of the result of the comparison step; in order to improve the quality assessment, the control device carries out the following further steps while the pipetting channel is filled exclusively with working gas as fluid:—carrying out corrective-pressure determination by moving the pipetting plunger, and—measuring a pressure of the working gas in the pipetting channel as a corrective pressure during the corrective-pressure determination, wherein, prior to the comparison step, the control device corrects the time curve of the working-gas pressure recorded during the metering process on the basis of the corrective pressure measured during the, so that the comparison step is carried out using the corrected time curve of the working-gas pressure.

This application claims priority in PCT application PCT/EP2023/074049 filed Sep. 1, 2023, which claims priority in German Patent Application DE 10 2022 123 672.2 filed on Sep. 15, 2022, which are incorporated by reference herein.

The present invention concerns a method for quality-assessed metering of a metering fluid by means of a pipetting device, where the pipetting device comprises:
A pipetting duct filled at least in part with a working gas,
A pipetting piston accommodated movably in the pipetting duct in order to modify a pressure of the working gas in the pipetting duct through a piston movement,
A pipetting aperture traversable by metering fluid in order to alter the quantity of fluid received in the pipetting duct,
A piston drive in order to drive the pipetting piston to a movement along the pipetting duct,
A pressure sensor in order to capture the pressure of the working gas in the pipetting duct,
A control device for storage and processing of data and for actuating the piston drive,

Where the method comprises the following steps:
Performing a metering process by moving the pipetting piston and thereby modifying the pressure of the working gas in the pipetting duct and thereby altering the quantity of metering fluid received in the pipetting duct,
Capturing a temporal course of the pressure of the working gas in the pipetting duct during the metering process,
Comparing a course of the working gas pressure on the basis of the captured temporal course of the working gas pressure with a specified pressure target values range, and
Outputting a quality assessment of the metering process as a function of the result of the comparison step.

### BACKGROUND OF THE INVENTION

Such a method and a pipetting device arranged for carrying it out are known from WO 02/073215 A2. In the known method, a pressure target values range is specified though a curve of a pressure values upper limit and though a curve of a pressure values lower limit. The pressure target values range is determined beforehand in the laboratory for one type of pipetting devices and for one metering fluid or class of metering fluids each time, and recorded in a data memory of the control device of the pipetting device. Essentially, the curve of the pressure values lower limit corresponds to the curve of the pressure values upper limit and is merely displaced towards lower pressures.

When the captured temporal pressure course of the working gas in the pipetting duct during the metering process for a relevant period, this can for example be the period of a movement of the pipetting piston induced by the metering process, runs completely between the pressure values upper limit and the pressure values lower limit, the metering process is assessed as good and/or in order, respectively. However, when the temporally captured pressure course of the working gas in the pipetting duct leaves the pressure target values range, the metering process is assessed as faulty, where additionally depending on the location and the direction of leaving the pressure target values range, a distinction can be made between different possible error sources.

Here it has turned out that the pipetting ducts even of structurally identical pipetting devices differ due to manufacturing tolerances being realized. This leads to value-related dispersion of temporal pressure courses captured during a metering process, even though each individual metering process took place error-free. In order to avoid false-negative quality assessments of metering processes, the pressure target values range can be chosen correspondingly large. This, however, increases the risk of obtaining false-positive quality assessments, since then deviations from the norm during a metering process have to be especially significant in order to leave an enlarged pressure target values range beyond the upper pressure limit or under the lower pressure limit.

This problem is severely increased in practice first and foremost by the fact that for reasons of the highest possible process hygiene, the section of the pipetting duct wetted by metering fluid during the pipetting operation is formed by a replaceable pipetting tip normally used only once. Through the replacement of disposable pipetting tips, the pipetting duct of a pipetting device can, so to speak, change its metering characteristics with each pipetting tip in terms of interaction of pipetting duct and working gas during a metering process. Thereby, nominally structurally identical pipetting device differ with regard to their metering characteristics not only among each other, but rather the metering characteristics themselves are not constant, instead changing over the working life of the respective pipetting device. That is, even if a difference if metering characteristics could be corrected in some way, this correction can in the course of further operation of the pipetting device become unusable or even harmful through changes in the pipetting duct.

From EP 2 037 283 A1 there is known a piston-driven metering device for metering a metering fluid. The pressure of the working gas in the pipetting duct is captured with a pressure sensor. When during dispensing the pressure in the pipetting duct exceeds a specified threshold value, an analytical module of the device recognizes the pipetting aperture as blocked. The threshold value is determined here on a standard device with a reference metering fluid. The standard device is constructed essentially identically with the working metering device used for feeding an analytical device. However, despite being structurally identical, because of manufacturing tolerances being realized the pressure sensors exhibit fluctuations in their sensitivity of up to 30%. As a consequence, an identical process, one time carried out on the standard device and another time carried out on the working metering device, can lead in each case to pressure sensor signals which can differ at the same process progress point by up to 30%.

In order to make the signals of the working metering device comparable with those of the standard device, for instance with the threshold value determined there, EP 2 037 283 A1 proposes the use of a correction factor which is applied to the signals of the working metering device. The correction factor corresponds to the ratio of the sensitivity of the pressure sensor in the standard device to that of the working metering device. By multiplying the signal of the pressure sensor of the working metering device by the correction factor, corrects this signal to the signal level of the standard device.

It is readily recognizable that EP 2 037 283 A1 is not applicable to differences which vary during the working life of a working metering device between the working metering device and the standard device or that such temporally variable differences can only be corrected through repeated costly comparative metering procedures.

From WO 2016/025849 A1 there is known a method for checking the integrity of a pipetting tip at a pipetting device. For this purpose, WO 2016/025849 A1 proposes aspirating gas into a pipetting tip couped to a pipetting device and during a specified period of the aspiration determining a maximum and a minimum pressure value. Starting from the determined maximum and minimum pressure value, a pressure values range of the pipetting tip bounded by the maximum and the minimum pressure value is determined. The pressure values range is compared with a specified upper threshold value and with a specified lower threshold value. If the determined pressure values range lies between the upper and the lower threshold value, the performing device assesses the pipetting tip as functioning correctly, otherwise the pipetting tip is rejected.

### SUMMARY OF THE INVENTION

Proceeding from the method described at the beginning, it is the task of the present invention to provide a technical approach which makes it possible, in view of the value-related dispersions of captured temporal courses of the pressure of the working gas in the pipetting duct described above, to increase the accuracy of the quality assessment of the metering process carried out.

The present invention solves this task by having the control device perform the following further steps while the pipetting duct is essentially filled solely with working gas as a fluid:
The control device performs a correction pressure determining process. For this purpose, it actuates the piston drive and moves the pipetting piston. This movement of the pipetting pistons effects a change in the pressure of the working gas in the pipetting duct. Thereby, depending on the direction of movement of the pipetting piston, working gas is aspirated into the pipetting duct and/or working gas dispensed out of the pipetting duct.
During the correction pressure determining process, the control device by means of the pressure sensor captures a pressure of the working gas in the pipetting duct. In the further method, the pressure thus captured is a correction pressure.

In order to increase the accuracy of the assessment of the quality of the metering process, before the comparison step the control device corrects the temporal course of the working gas pressure captured during the metering process on the basis of the correction pressure of the working gas captured during the correction pressure determining process. The comparison step is therefore performed with the corrected temporal course of the working gas pressure.

An advantage of this method according to the invention is that the correction pressure is determined at the same pipetting duct with which the metering process is performed also. Therefore, a correction pressure is determined which represents exactly that pipetting duct whose metering behavior is relevant for assessing the quality of the performed metering process.

Part of the pipetting duct is never reached by metering fluid even in metering processes with large metering volumes, but rather is always filled only with working gas. The working gas moved during the correction pressure determining process reproduces very accurately for this region of the pipetting duct, which during the operation of the pipetting device is always filled only with working gas, its characteristics in the interaction with the working gas for the metering process also.

Part of the region of the pipetting duct always filled only with working gas is formed when using exchangeable pipetting tips by the respective pipetting tip itself, which in metering processes is never filled completely with metering fluid. In particular, when in the exchangeable pipetting tip there is arranged a filter through which the working gas flows during the metering process, on the one hand the filter is situated in the region of the pipetting tip always filled only with working gas and on the other the filter contributes to an especially high degree to the individual characteristics of the respective pipetting tip and thereby of the currently used pipetting duct of the pipetting device in its interaction with the working gas.

It is precisely for these filters that it is easy to understand that the filters exhibit particular filter characteristics in order to hold back particular undesirable constituents in the working gas. These filter characteristics can be achieved through a particular pore size in the filter material of the filter, where the distribution of different pore sizes in the filter can be subject to a comparatively large stochastic dispersion. Thus, pipetting tips can exhibit filters which essentially have the same filter effect but which during a metering process impact differently the working gas pressure created through the movement of the pipetting piston.

The aforementioned filter in the pipetting tip is merely an especially clear example of different interactions of nominally structurally identical pipetting tips with the working gas in the pipetting duct. Other effects, such as dimensional differences of pipetting tips usually fabricated in the injection molding method effected through permitted manufacturing tolerances or through different thermal expansions due to different operating temperatures, can equally impact the interaction of the pipetting duct with the working gas during a metering process, like transient condensate precipitations on wall sections of the pipetting duct. The presented method is therefore especially advantageous for filter-carrying pipetting tips, but not only for these. The individual effects of the pipetting duct can be determined through the aforementioned steps which are performed additionally to the already known method near the time of the actual metering process and taken into account in a corrective manner on the pressure course indicating the quality of the metering process.

A best possible correction can be obtained at the lowest possible cost by having the correction pressure determining process as far as possible not differing or differing as little as possible from the subsequent metering process. An essential difference, namely the presence of metering fluid in the pipetting duct during the metering process in contrast to the pipetting duct being filled solely with working gas during the correction pressure determining process, is however unavoidable. However, agreement between the correction pressure determining process and the metering process can be created by the pipetting piston being moved during the correction pressure determining process in the same direction of movement as during the metering process. Therefore, if the metering process depends essentially on an aspiration of metering fluid, the correction pressure is preferably determined in the correction pressure determining process during a movement of the pipetting piston in the aspiration direction. For a dispensing process as a metering process, the equivalent applies mutatis mutandis.

In principle it is conceivable to repeat the piston movement of the metering process during the correction pressure determining process ‘dry’, i.e. with a pipetting duct filled only with working gas, with identical stroke and identical piston acceleration and velocity and to capture the temporal course of the pressure of the working gas during the correction pressure determining process as the correction pressure. Then the temporal course of the working gas pressure determined during the metering process can be corrected by the temporal course of the working gas pressure determined during the counter-pressure determining process.

Although this procedure promises high correction accuracy, it considerably impairs the productivity of the pipetting device. Higher productivity of the pipetting device along with sufficiently accurate correction can be obtained by having the pipetting piston moved at a constant movement velocity during the correction pressure determining process and capturing the correction pressure of the working gas during the movement phase of constant movement velocity. The temporal course of the working gas pressure during the metering process can then be corrected with this constant value of the correction pressure. The accuracy in this simplified method lies in capturing, through the capturing of the correction pressure during the constant movement velocity of the pipetting piston, a quasi-static state in the sense of an unaccelerated state of the working gas. That is to say, during a phase of the metering process between phases of acceleration and of deceleration of the pipetting piston too, the pipetting piston is moved at a constant velocity. Thus the simplified correction pressure determining process describes sufficiently accurately the metering process performed with the same pipetting duct.

A further productivity increase and/or as the case may be minimization of an impairment of the productivity of the pipetting device through the correction pressure determining process can be achieved by having the pipetting piston moved during the correction pressure determining process at a different velocity than during the metering process. Preferably, the pipetting piston is moved during the correction pressure determining process at a higher velocity, in particular at higher constant velocity, than during the metering process.

For this purpose, there can be recorded in a data memory for a respective used type of the pipetting duct, in particular a pipetting tip, a data correlation which links different correction pressures with different piston velocities. Such a data correlation can be determined beforehand in the laboratory for the individual types of pipetting tips and/or of pipetting ducts respectively. The type of the pipetting duct can be determined by its length, its flow cross-section, its sequence of different flow cross-sections etc, generally through its shape. The type of a pipetting tip can be determined by its shape and its nominal pipetting volume. Surprisingly, as far as the practicality of a data correlation which assigns different piston velocities to respective different correction pressures which are captured there is concerned, it does not depend on whether the pipetting tip carries a filter or not. Indeed, the filter has a considerable impact on the interaction of the pipetting tip with working gas moved therein. However, the correction pressures of filter-carrying pipetting tips at different piston velocities behave approximately the same as the correction pressures of otherwise structurally identical but filter-less pipetting tips at the same different piston velocities. In so far as in the conversion of a correction pressure determined at the first piston velocity into an expected correction pressure occurring at a second piston velocity different from the first there is dependence only on the ratio of the two correction pressures, the ratios of the correction pressures of filter-carrying and filter-less otherwise nominally structurally identical pipetting tips differ only insignificantly, such that a data correlation which was determined for a type of pipetting tips only for filter-carrying pipetting tips can also be used for filter-less pipetting tips of the same type, i.e. of the same shape and the same nominal pipetting volume.

Therefore, the control device preferably determines, starting from the correction pressure actually captured at the piston velocity of the correction pressure determining process, on the basis of the aforementioned data correlation, an expected correction pressure assigned to the piston velocity of the metering process. The control device then further corrects the temporal course of the working gas pressure captured during the metering process with the expected correction pressure.

For example, for the respective type of the pipetting duct being used, i.e. in particular the pipetting tip, a previously determined data correlation can be recorded in the data memory retrievable by the control device, which links a constant piston velocity v_{K} with the correction pressure pₖₒᵣᵣ determined during a piston movement at this piston velocity. The suffix ‘calib’ indicates that the correction pressure belongs to the data correlation. The data correlation can be a table, a characteristic diagram, or, and this is preferable, a functional relationship. Then we have for a first piston velocity 1 v_{K}:

$${}_{1} {p}_{corr}^{c a l i b} = f {(}_{1} {v}_{K} ) \qquad Eq . 1$$

Here it has turned out that a linear relationship between the constant piston velocity v_{K} and the associated correction pressure pₖₒᵣᵣ, as it can be obtained through linear regression starting from measurement points produced at different piston velocities, describes sufficiently accurately the relationship between piston velocity and correction pressure.

We get quite generally for the ratio of two correction pressures determined at different piston velocities:

$$\frac{{}_{1} {p}_{corr}^{c a l i b}}{{}_{2} {p}_{corr}^{c a l i b}} = \frac{f {(}_{1} {v}_{K} )}{f {(}_{2} {v}_{K} )} \qquad Eq . 2$$

The ratio

$$\frac{f {(}_{1} {v}_{K} )}{f {(}_{2} {v}_{K} )}$$

from Eq. 2 can be determined from the previously determined data correlation alone. Simplified, the ratio can be written as ₂₋₁k^{calib} which links together the correction pressures determined at different piston velocities 1 v_{K} and 2 v_{K} in accordance with the previously determined data correlation.

$$\frac{{}_{1} {p}_{corr}^{c a l i b}}{{}_{2} {p}_{corr}^{c a l i b}} = \frac{f {(}_{1} {v}_{K} )}{f {(}_{2} {v}_{K} )} = {}_{2 - 1} {k}^{calib} \qquad Eq . 2 a$$

For the aforementioned linear relationship, preferred due to its simplicity, we then have:

$${}_{2 - 1}^{lin} {k}^{c a l i b} = \frac{a \cdot {}_{2} {v}_{K} + b}{a \cdot {}_{1} {v}_{K} + b} \qquad Eq . 3$$

Now the pipetting ducts, in particular their pipetting tips, are always subject to manufacturing tolerances, which lead to diverging dimensions of nominally structurally identical pipetting ducts, in particular pipetting tips, such that the same piston velocities in nominally structurally identical pipetting ducts can lead to different correction pressures. This also applies to the pipetting ducts used beforehand in the laboratory to determine the data correlation in comparison with the pipetting ducts used for the respective metering process and thereby for the respective correction pressure determining process belonging to the metering process. Here the inventors have, however, found out that pipetting ducts of identical construction can indeed result in different values for the captured correction pressure at one and the same piston velocity, but that the correction pressures determined at different piston velocities always remain with sufficient accuracy in the same ratio to one another regardless of their concrete value.

If therefore the correction pressure determining process is always performed at the same first piston velocity, whereas the metering process is performed at a second piston velocity different from it, then we have:

$${}_{2} {p}_{corr}^{met} = {}_{1} {p}_{corr}^{c d} \cdot \frac{f {(}_{1} {v}_{K} )}{f {(}_{2} {v}_{K} )} \qquad Eq . 4$$

$$or$$

$${}_{2} {p}_{corr}^{met} = {}_{1} {p}_{corr}^{c d} \cdot {}_{2 - 1} {k}^{c a l i b} \qquad Eq . 4 a$$

The suffix ‘met’ indicates that the correction pressure belongs to the metering process, the index ‘2’ indicates that it is assigned to the piston velocity 2 v_{K} used in the metering process. The suffix ‘cd’ indicates that the correction pressure was determined during the correction pressure determining process. The index ‘1’ indicates that this determination took place when using the piston velocity 1 v_{K}.

Thus the expected correction pressure at the second piston velocity can be determined sufficiently accurately simply from the correction pressure actually measured at the first piston velocity on the basis of the aforementioned data correlation. This works even when Equation 1 was determined for a type of pipetting duct, in particular for a type of pipetting tips, only for a filter-carrying or only for a filter-less variant of this type, but now for the metering device the respective other variant of the same type is used. The ratio quotient which essentially determines the conversion in Equations 4 or 4a respectively does not differ essentially, or only to a negligible extent, for filter-carrying and filter-less variants for the accuracy assessment for one and the same type of pipetting duct or pipetting tips respectively.

Since out of all causes contributing to the dispersion of the pressure of working gas in a pipetting duct during the metering process, a filter or more precisely filter element in the pipetting duct, in particular in the pipetting tip, makes the biggest contribution to the dispersion, the method can only be performed in filter-containing pipetting ducts, in particular pipetting tips.

The correction presented above of an effect created largely through a filter in the pipetting duct by subtracting an individual correction pressure from the temporal course of the working gas pressure captured during a metering process, can be understood approximately as subtraction of the effect produced by the filter on the pressure of the working gas from the captured course of the working gas pressure. For example, in experiments it has been shown that the effect of a filter in the pipetting duct is greater by a factor of 20 or more than the effect of other interfering factors on the working gas pressure in the pipetting duct. Consequently, the described correction approximates the captured temporal courses of the working gas pressure during a metering process with filter-carrying pipetting ducts to those temporal courses which are performed with nominally structurally identical but filter-less pipetting ducts. According to a preferred development of the present invention, therefore, the same pressure target values ranges can be used for nominally structurally identical pipetting ducts, in particular nominally structurally identical pipetting tips, regardless of whether the pipetting ducts, in particular the pipetting tips, exhibit a filter or not. A pressure target values range is always assigned here to a concrete quantity to be metered of metering fluid and a particular metering fluid or class of metering fluid. Because of the great impact of the indicated filter on the pressure of the working gas, this is a considerable simplification in day-to-day pipetting operation. This simplification is even useful when only metering processes performed with filter-carrying pipetting tips are corrected according to the method, the metering processes performed with filter-less pipetting tips in contrast are not.

In order to achieve productivity gains and/or to minimize productivity losses, as the case may be, as already stated above the piston velocity of the correction pressure determining process is preferably higher than the piston velocity of the metering process. The correction pressure determining process is preferably performed at the highest possible piston velocity for the respective type of pipetting duct, in particular the respective pipetting tip being used. The piston velocity during the correction pressure determining process preferably lies at least in the range from 90% to 100% of the maximum possible piston velocity for the respective type of pipetting duct. If the type of pipetting duct does not limit upwards the usable piston velocity, the correction pressure determining process is preferably performed at a piston velocity in the range from 90% to 100% of the maximum possible piston velocity of the pipetting device.

Alternatively, the piston velocity can be chosen so high that the flow of working gas in the pipetting duct effected thereby is only just still laminar and does not flip over into turbulent flow. This piston velocity can be determined beforehand in the laboratory for each type of pipetting tips.

In case of doubt, the term ‘piston velocity’ indicates the constant piston velocity occurring during the correction pressure determining process and during the metering process. For the unlikely case that two or more different constant piston velocities occur during the indicated processes, let the highest occurring constant piston velocity be the piston velocity indicated above.

In principle, the correction pressure can be an absolute pressure of the working gas in the pipetting duct. In order to simplify the correction of the temporal course of the working gas pressure during the metering process, the correction pressure is the same type of pressure as the pressure of the working gas. Since normally the temporal course of the working gas pressure captured during the metering process is a differential pressure between the absolute pressure of the working gas and the absolute pressure of the ambient atmosphere, preferably the correction pressure is also a differential pressure between the ambient pressure of the pipetting duct and the absolute pressure of the working gas in the pipetting duct. Then the correction step can comprise in an especially simple manner a decrease in terms of magnitude of the temporal course of the working gas pressure captured during the metering process in order to capture the correction pressure. For example, the correction pressure can in a simple manner be deducted from the temporal course of the working gas pressure during the metering process. Thus the temporal course of the working gas pressure during the metering process is cleaned of effects which occur in the piston movement in the pipetting duct regardless of whether or not metering fluid is metered with the pipetting duct.

In principle, the pipetting duct can be a rigid tube. For reasons of the highest possible process hygiene, it is preferable for the pipetting duct to exhibit a trunk duct with a coupling formation for temporary coupling of a pipetting tip. The method discussed here then preferably exhibits the coupling of a pipetting tip to the trunk duct. The trunk duct and the pipetting tip coupled to it then form together the pipetting duct of the pipetting device. In order to be certain that the correction pressure for the pipetting tip is determined with which the metering process is also performed, the correction pressure determining process is preferably performed after the coupling of the pipetting tip.

In principle it is to begin with immaterial whether the correction pressure determining process is performed before or after the metering process. Precisely in aspiration processes, however, the correction pressure determining process after the coupling of a new pipetting tip can be performed with high accuracy directly on a clean pipetting tip unaffected by residues of metering fluid. Thus preferably the correction pressure determining process is performed before the metering process.

The control device can during the metering process capture the temporal course of the working gas pressure over the entire metering process, i.e. from a beginning of the piston movement or shortly before it up to a return of the working gas pressure to a constant value after a renewed standstill of the piston movement. However, for assessing the quality of the performed metering process it can suffice if the control device corrects the temporal course of the working gas pressure captured during the metering process only up to the end of the movement of the pipetting piston. After the end of the movement of the pipetting piston, there take place in the pipetting duct only pressure-equalization processes and the subsiding of any possibly oscillating column of metering fluid, which however normally has no noteworthy impact on the quality of the preceding metering process.

Likewise, under further simplification of the method's implementation it can suffice without loss of accuracy when assessing the quality of the performed metering process to begin a correction of the temporal course of the working gas pressure captured during the metering process only from a point in time lying in a time interval whose duration equals no more than 10%, preferably no more than 5%, of the movement duration of the pipetting piston during the metering process and which contains the point in time at which metering fluid driven by the piston movement begins to flow through the pipetting aperture.

The aforementioned end of the pipetting piston movement can be determined readily from the operating data of the control device and/or of the pipetting device as the case may be. In contrast to the end of the movement of the pipetting piston, the beginning of a flow of metering fluid through the pipetting aperture is not a direct operation of a component of the pipetting device, but only a consequence of same. Nevertheless, the beginning of a flow of metering fluid through the pipetting aperture is displayed in the captured temporal course of the working gas pressure sufficiently distinctly as a kink and/or as a spon-taneous change in the gradient of the pressure course, as the case may be, such that this point in time of the beginning of a flow movement can also be ascertained sufficiently distinctly. This is additionally elucidated further below by reference to the embodiment example.

According to the assessment method already known from the state of the art, it is also provided for the present assessment method with pressure correction that the control device outputs a positive quality assessment if the comparison step yields that the course of the working gas pressure, preferably the temporal course of the working gas pressure corrected by the correction pressure, lies within a predefined section completely within the predetermined pressure target values range. Alternatively or preferably additionally, it can be provided that the control device outputs a negative quality assessment if the comparison step yields that the course of the working gas pressure, preferably the temporal course of the working gas pressure corrected by the correction pressure, lies within a predefined section outside the predetermined pressure target values range. The output of the quality assessment can take place through light signals, through text output on a monitor and/or on printing paper, through speech output, through acoustic signals, and the like.

Alternatively or preferably additionally, the control device can identify the faulty pipetting in pipetting protocols and/or repeat the faulty metering process with a new pipetting tip.

In case of doubt, the mentioned method steps are performed directly or induced by the control device. The latter applies in particular to the comparison step and the correction step.

In accordance with the above, the present invention additionally concerns a pipetting device, comprising:
A pipetting duct filled at least in part with a working gas,
A pipetting piston accommodated movably in the pipetting duct in order to modify a pressure of the working gas in the pipetting duct through a piston movement,
A pipetting aperture traversable by metering fluid in order to alter the quantity of fluid received in the pipetting duct,
A piston drive in order to drive the pipetting piston to a movement along the pipetting duct,
A pressure sensor in order to capture the pressure of the working gas in the pipetting duct, and
A control device for storage and processing of data and for actuating the piston drive,

Where the control device is designed for implementing a method as described and developed above. The description of the method provided above serves also to describe the pipetting device designed for implementing this method. The concrete design for implementing this method lies normally in the control device of the pipetting device. The control device normally comprises a data memory and at least one integrated circuit. In the data memory there can be stored sensor signals, for instance of the pressure sensor. Over and above that, there can be recorded in the data memory an operating program for operating the pipetting device.

The control device can be formed by several cooperating part-control devices. Likewise the data memory can comprise several part-data memories.

Since the method presented here achieves its special advantage when the variability of the characteristics of the pipetting duct in the interaction with the working gas by exchanging different pipetting tips is especially large, the pipetting duct of the pipetting device preferably exhibits a trunk duct with a coupling formation for temporary coupling of a pipetting tip. The coupling formation can be a coupling adapter which can be inserted into a corresponding longitudinal-end counter-coupling formation, for instance in the shape of a socket or bushing section of the pipetting tip.

Therefore the pipetting device preferably exhibits a pipetting tip coupleable to the coupling formation as part of the pipetting duct, where the pipetting tip exhibits for this purpose a counter-coupling formation complementary to the coupling formation. ‘Complementary’ should not be understood here as an obligatory negative shape relative to the coupling formation as a positive shape. The counter-coupling formation is sufficiently complementary to the coupling formation when after insertion into the counter-coupling formation the coupling formation is arranged in a fitting and gastight manner in the counter-coupling formation. The trunk duct and the pipetting tip coupled to it then form together the pipetting duct of the pipetting device.

Because of the special value of the method described above for correcting fluctuations in the characteristics of a filter-containing pipetting tip in the interaction with moving working gas, preferably the pipetting tip not only exhibits the pipetting aperture in a manner which is known per se, but rather the pipetting tip preferably exhibits in a section between the pipetting aperture and the counter-coupling formation a porous filter. The pipetting device can according to the above explanation even be designed to correct only captured temporal courses of the working gas pressure of metering processes which were performed with filter-carrying pipetting tips.

The pipetting device or more precisely its control device can, for assessing the quality of a metering process for the metering of one and the same quantity of one and the same metering fluid, use one and the same pressure target values range once for filter-carrying and once for filter-less pipetting tips of the nominally same type.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 A rough schematic view of a pipetting device according to the invention, designed for implementing the method according to the invention,

FIG. 2 A rough schematic depiction of a temporal course of the working gas pressure in the pipetting duct of the pipetting device of FIG. 1 during an aspiration process, without correction of the pressure course,

FIG. 3 A rough schematic depiction of a temporal course of the working gas pressure in the pipetting duct of the pipetting device of FIG. 1 during a dispensing process, without correction of the pressure course,

FIG. 4 A rough schematic depiction of predetermined data correlations of constant velocity of the piston of the pipetting device of FIG. 1 and correction pressures of the working gas captured at the same time in the pipetting duct, and

FIG. 5 A rough schematic depiction of a set of temporal courses of working gas pressure in the pipetting duct of the pipetting device of FIG. 1, each corrected by an individually determined correction pressure.

### DESCRIPTION OF PREFERRED EMBODIMENTS

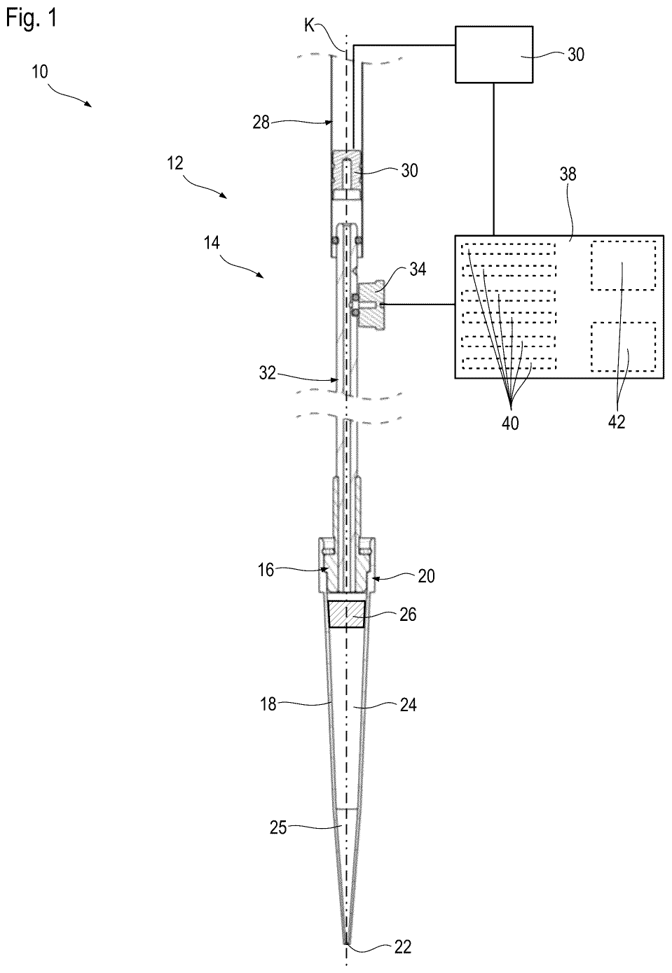

Referring now to the drawings wherein the showings are for the purpose of illustrating preferred and alternative embodiments of the invention only and not for the purpose of limiting the same, in FIG. 1, an embodiment of a pipetting device according to the invention is labeled generally by 10. The pipetting device 10 comprises a pipetting duct 12 extending along a duct axis K. The pipetting duct 12 is implemented in several parts and comprises a pipetting device-tight trunk duct 14 with a coupling formation 16. The pipetting duct 12 further comprises an exchangeable pipetting tip 18 coupled to the coupling formation 16.

The pipetting tip 18 comprises at its longitudinal end which is coupled with the coupling formation 16 a counter-coupling formation 20 and comprises at its other longitudinal end a pipetting aperture 22. The pipetting aperture 22 opens the pipetting tip 18 towards a receiving volume 24 into which metering fluid, for example the metering fluid 25, can be received through the pipetting aperture 22 and out of which metering fluid 25 can be released through the pipetting aperture 22.

In a region of the pipetting tip 18, which in the proper pipetting operation is always filled only with a working gas, for instance air, there is accommodated a filter element 26. The filter element 26 can be formed from a tangle of fibers and/or from a sintered particulate material and/or from an open-cell foam of specified porosity.

The trunk duct 14 is once again designed in several parts. In a section 28 of the trunk duct 14 which lies further away from the coupling formation 16 along the duct axis K there is accommodated moveably along the duct axis K a pipetting piston 30.

To the section 28 of the trunk duct 14 accommodating the pipetting piston 30 there is connected a further section 32 of the trunk duct 14 which exhibits a narrower duct cross-section than the section 28 accommodating the pipetting piston 30, such that the pipetting piston 30 cannot leave the section 28 towards the coupling formation 16. In the section 32 there is arranged a pressure sensor 34 which is designed to capture the pressure of the working gas in the pipetting duct 12.

The trunk duct 14 is always filled with working gas only. The pipetting tip 18 is likewise, starting from its counter-coupling formation 20 towards the pipetting aperture 22 up to beyond the filter element 26, always filled with working gas only. In proper operation, the pipetting tip 18, from the pipetting aperture 22 in the axial direction towards the counter-coupling formation 20, is filled either with working gas or with metering fluid 25. In proper pipetting operation, the pipetting tip 18 is filled with metering fluid 25 at most up to its nominal volume. Other than working gas and metering fluid, no further fluids are present in the pipetting duct 12.

The pipetting piston 30 is coupled with a piston drive 36, through which the pipetting piston 30 can be driven to movement along the duct axis K in the section 28 of the pipetting duct 12. The piston drive 36 can be a conventional mechanical drive, for instance a spindle drive, or can be a linear motor drive in which the pipetting piston 30 forms a permanent magnetic rotor.

The piston drive 36 is connected with a control device 38 for signal transmission, such that the control device 38 can actuate the piston drive 36 to achieve a movement of the pipetting piston 30. The piston drive 36 can via a line connecting it with the control device 38 transmit to the latter data which indicate the current position of the pipetting piston 30 in the pipetting duct 12.

The control device 38 comprises several integrated circuits 40 and several data memories 42, in which sensor data can be stored and read out and in which predetermined data correlations and operating programs can be recorded.

As already known from WO 02/073215 A2, the pressure of the working gas in the pipetting duct 12 during an aspiration process and during a dispensing process shows a characteristic temporal course which can be used for checking the quality of the performed metering process, be it an aspiration process or a dispensing process.

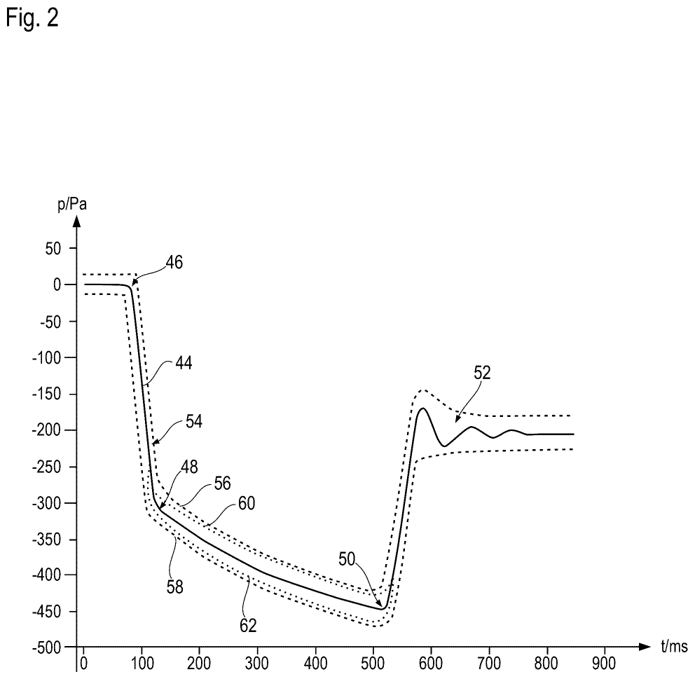

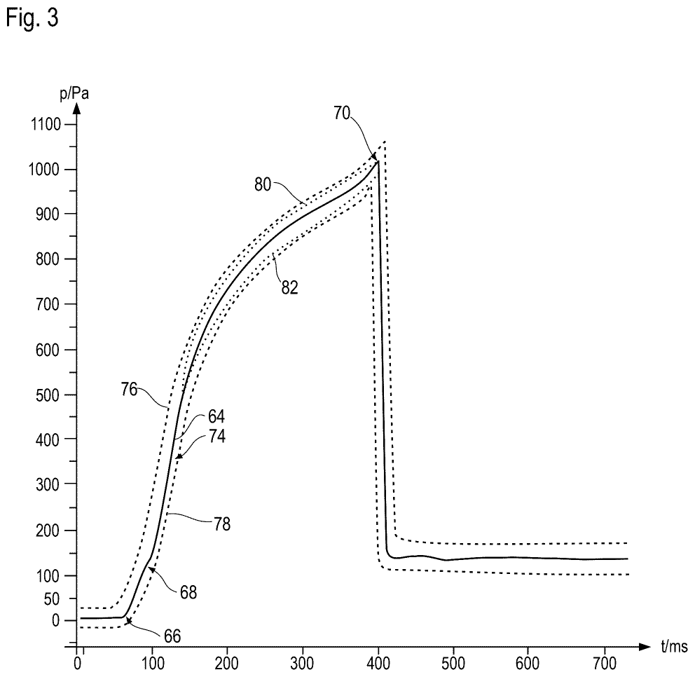

In FIG. 2 there is shown the temporal course of an—uncorrected—pressure of the working gas in the pipetting duct 12 during an aspiration process by way of example and in rough schematic form. In FIG. 3 there is shown the temporal course of an—uncorrected—pressure of the working gas in the pipetting duct 12 during a dispensing process by way of example in rough schematic form.

In FIG. 2 there is shown the temporal course of the pressure of the working gas in the pipetting duct 12 during an aspiration process as a solid line 44, as captured by the pressure sensor 34. The pressure of the working gas is depicted as a differential pressure relative to the ambient pressure.

The aspiration process begins in an empty pipetting tip 18 at a differential pressure relative to the ambient pressure of 0 Pa. At approximately point 46 the pipetting piston 30 begins to move, which is why the pressure of the working gas in the pipetting duct 12 at first drops steeply. At point 48, the negative pressure in the receiving space 24 of the pipetting tip 18 is so great that metering fluid 25 begins to flow through the pipetting aperture 22 into the receiving space 24. The pipetting piston is moved at a constant velocity. The inflowing metering fluid 25 ensures a less rapid pressure drop of the working gas in the pipetting duct 12. The pressure of the working gas in the pipetting duct 12 drops until the end of the movement of the pipetting piston at point 50 approximately linearly with time.

After the end of the movement of the pipetting piston 30, metering fluid 25 continues flowing into the receiving space 24, driven by the still present negative pressure in the pipetting duct 12 and in particular in the receiving space 24 of the pipetting tip 18. In the absence of further movement of the pipetting pistons 30, this after-flow of metering fluid 25 leads to a rapid decrease in the negative pressure of the working gas relative to the ambient pressure in the pipetting duct 12 until equilibrium between the negative pressure of the working gas continuing to be present in the pipetting duct 12 as holding pressure and the quantity of metering fluid 25 received into the pipetting duct 12 is reached. Since on reaching the equilibrium state the inflowing metering fluid 25 stops flowing, the thus delayed liquid column in the receiving space 24 of the pipetting tip 18 can reverberate, which is depicted in curve 44 as a subsiding pressure fluctuation in region 52.

The curve 44 of the temporal course of the working gas in the pipetting duct 12 is a curve of a successful aspiration process which has taken place without errors. It runs completely within a pressure target values range 54, which indicates for the aspirated in terms of quantity and type of metering fluid 25 the permitted values of the pressure of the working gas in the pipetting duct 12 at each point in time of the aspiration process.

The pressure target values range 54 is limited towards higher pressures by a curve 56 depicted by a dashed line, which represents an upper limit of the pressure target values range 54. Likewise, the pressure target values range 54 is limited towards lower pressures by a curve 58 depicted by a dashed line, which represents a lower limit of the pressure target values range 54. As long as during a metering process, here during an aspiration process, the temporal course of the captured pressure of the working gas in the pipetting duct 12 proceeds between the upper limit 56 and the lower limit 58, the aspiration process is regarded as error-free.

When the temporal course of the captured pressure of the working gas leaves the pressure target values range 54, the aspiration process is regarded as faulty. Depending on where and how the captured temporal course of the working gas pressure leaves the pressure target values range 54, different error causes can be inferred. To this end, the description already provided in this respect in WO 02/073215 A2 is referred to. If for example the temporal course of the working gas pressure falls below the lower limit 58, this can be down to a blockage of the pipetting aperture 22. If the temporal course exceeds the upper limit 56, this can for example be down to undesirable foam generation in the metering fluid 25 or an excessively short aspiration process.

Pipetting devices 10 with pipetting ducts 12 of the same type, in particular with pipetting tips 18 of the same type, can with an essentially identically proceeding piston movement of the pipetting piston 30 for the aspiration of one and the same quantity of one and the same metering fluid lead to different pressure courses of the working gas pressure in the pipetting duct 12 due to manufacturing tolerances being realized, in particular of the pipetting tip 18 and within the latter especially of the filter element 26. The dotted lines 60 and 62 marked in FIG. 2 indicate by way of example and in a rough schematic manner an upper limit (line 60) and a lower limit (line 62) of the dispersion of the captured temporal course of the working gas pressure.

In order to avoid false-negative assessments of the quality of the aspiration process, given the stated dispersion the pressure target values range 54 should be chosen so large that the entire dispersion range of the captured temporal course of the working gas pressure lies in the pressure target values range 54. However, on the other hand such a wide pressure target values range 54 increases the risk of false-positive assessments of the quality of the aspiration process.

The same applies correspondingly to the dispensing process depicted in rough schematic form in FIG. 3. The temporal course of the working gas pressure in the pipetting duct 12 during the dispensing process is depicted by the solid line 64.

At 66 there begins the movement of the pipetting piston 30, at 68 metering fluid 25 begins to exit out of the receiving space 24 through the pipetting aperture 22. At 70 the movement of the pipetting piston ends and the overpressure of the working gas in the pipetting duct 12 relative to the ambient pressure falls abruptly. The pressure level of the working gas at the end of the dispensing process is determined by the quantity of metering fluid remaining in the receiving space 24. The control device 38 preferably sets the pressure value supplied by the pressure sensor 34 at the beginning of a dispensing process to zero, such that the pressure values supplied during the dispensing process indicate the deviation from the compulsorily chosen starting value of zero. The zero setting corresponds to a shifting of the curve 64 along the ordinate such that the curve 64 begins at zero. The pressure value reached at the end of a dispensing process is therefore positive. This represents a holding pressure in order to continue holding the residual quantity of metering fluid remaining in the receiving space 24 in the pipetting tip 18. Since at the end of the dispensing process less metering fluid 25 is received in the receiving space 24 than at the beginning of same, the holding pressure as a negative differential pressure is smaller in magnitude at the end of the dispensing process but as a pressure value greater than at the beginning of the dispensing process. Through the zero setting of the pressure value supplied by the pressure sensor 34 at the beginning of the dispensing process, the recorded dispensing pressure curve 64 is shifted towards more positive values, which is why the holding pressure at the end of the dispensing process is positive. The control device 38 can also at the beginning of an aspiration process, in an analogous manner, shift the pressure value supplied by the pressure sensor 34 into the zero point of the ordinate, i.e. set it to zero.

The pressure target values range for the temporal course of the working gas pressure during a dispensing process is indicated in FIG. 3 by 74. In analogy with the pressure target values range 54 for the aspiration process, the pressure target values range 74 for the dispensing process is defined by a dashed line showing the upper limit 76 and by a dashed line showing the lower limit 78.

The dispersion of captured pressure values of the working gas pressure during a dispensing process due to realized manufacturing tolerances, despite the use of nominally type-identical pipetting tips and a nominally type-identical trunk duct 14 for dispensing an identical quantity of an identical metering fluid, is indicated again in FIG. 3 by dotted lines, namely by a dotted upper limit 80 and by a dotted lower limit 82 of the dispersion range.

As in the case of the aspiration process, false-negative quality assessments of a dispensing process can only be avoided by the choice of an appropriately large pressure target values range 74, where enlarging the pressure target values range 74 increases here too the risk of undesirable false-positive quality assessments.

In order to avoid the aforementioned dispersion of the values of the working gas pressure, after the coupling of a new pipetting tip 18 and before the first metering of metering fluid with the new coupled pipetting tip 18 the control device 38 performs a correction pressure determining process in which the pipetting piston, with the pipetting duct 12 being completely filled with working gas only, is moved at a constant velocity. The pressure of the working gas in the pipetting duct 12 prevailing during the piston movement at a constant velocity is captured with the pressure sensor 34 and recorded in the data memory 42.

In order to avoid productivity outages, the pipetting piston 30 is moved during the correction pressure determining process at the highest possible piston velocity. The piston velocity in pipetting devices is advantageously quoted as the volume traversed per unit time by the moving pipetting piston, i.e. for example in the unit μl per second (μl/s).

In the pipetting device 10, the highest possible piston velocity is 500 μl/s. At this constant piston velocity, the pipetting piston 30 is moved in the aspiration direction and at the same time the working gas pressure prevailing in the pipetting duct 12 measured as differential pressure relative to the ambient pressure. This captured correction pressure equals for example −350 Pa.

The aspiration process subsequently performed with the same pipetting tip 18 is performed not at 500 μl/s, but only at a piston velocity of 200 μl/s.

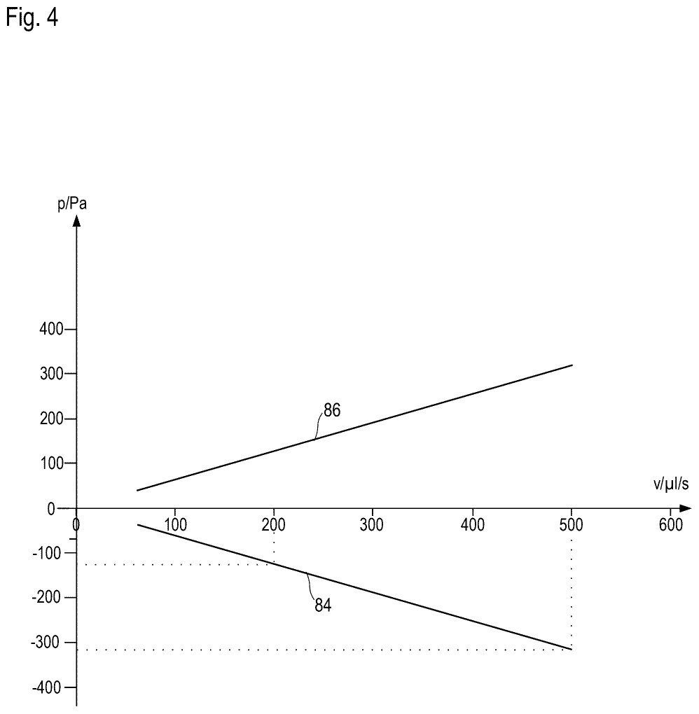

In order to convert the correction pressure actually captured at a higher piston velocity to a correction pressure expected at the actual piston velocity of the metering process, a data correlation shown in FIG. 4 is recorded in the data memory 42 of the control device 38. More accurately, there are recorded in the data memories 42 a data correlation 84 for aspiration and a further data correlation 86 for dispensing with the relevant pipetting tip 18. The data correlations were determined beforehand in a pipetting device structurally identical with the pipetting device 10 for a trunk duct 14 nominally structurally identical with the trunk duct 14 and for a pipetting tip 18 nominally structurally identical with the pipetting tip 18.

Since in the pipetting tip 18 which was used for determining the data correlation 84 for the aspiration the permissible manufacturing tolerances were realized in a different manner than in the pipetting tip 18 actually coupled during the performance of the correction pressure determining process, a correction pressure of −318 Pa is recorded in the data correlation 84 for the piston velocity of 500 μl/s. This is smaller in magnitude than the correction pressure of −350 Pa determined during the correction pressure determining process.

Nevertheless, the inventors have found out that for structurally identical pipetting tips 18 and/or for structurally identical pipetting ducts 12 as the case may be the correction pressures determined at different piston velocities always relate equally to one another regardless of their respective absolute value.

In the data correlation 84, a correction pressure of −125 Pa is recorded for the piston velocity of 200 μl/s actually used in the metering process.

With Equations 4 and/or 4a mentioned in the descriptive introduction, the correction pressure expected in the aspirating metering process following the correction pressure determining process can be determined as:

$${}_{2} {p}_{corr}^{met} = - 350 Pa \cdot \frac{- 125 Pa}{- 318 Pa}$$

Thereby there results for the aspirating metering process performed between the points 48 and 50 at an essentially constant piston velocity of 200 μl/s an expected correction pressure of −137.6 Pa. The temporal course of the working gas pressure captured during the aspirating metering process is corrected, i.e. reduced, by this correction pressure. Since both the temporal course of the working gas pressure during the aspiration process and the expected correction pressure have a negative sign, the reduction in the temporal course of the working gas pressure by the expected correction pressure leads to a decrease in terms of magnitude of the course of the working gas pressure by the correction pressure.

For a dispensing process, the procedure followed in analogous mutatis mutandis, but using the data correlation 86 for a dispensing process.

For the aspiration process of FIG. 2 it can suffice to correct curve 44 of the working gas pressure only between the points 48 and 50. For the dispensing process of FIG. 3 it can suffice to correct the curve 64 of the working gas pressure only between the points 68 and 70.

Since an individual correction value can be determined with the correction pressure determining process described above for the relevant pipetting duct 12 performing the metering process and in particular the pipetting tip 18 coupled to it, the dispersion of the captured temporal course of the working gas pressure corrected by the correction value can be considerably reduced.

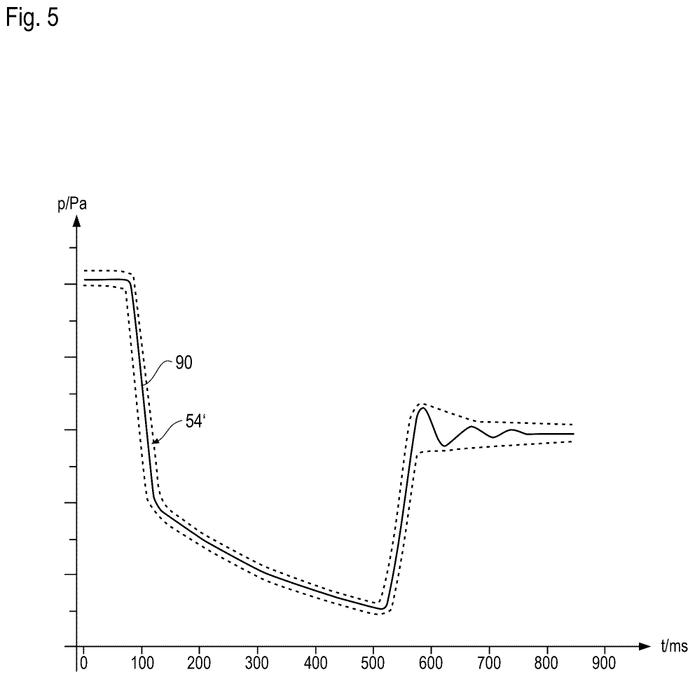

In FIG. 5 there is depicted with a solid line 90 a set of temporal courses corrected by respective correction values. Their dispersion is negligible. Consequently, the pressure target values range 54 can be defined as a new pressure target values range 54′ considerably more narrowly than the pressure target values range 54 of FIG. 2, without increasing the number of false-negative quality assessments. However, through the more narrowly defined pressure target values range 54′ the risk of undesirable false-positive quality assessments of aspiration processes is considerably reduced. The same applies mutatis mutandis to dispensing processes.

Thus the accuracy of the quality assessment of the performed metering process can be considerably improved through the correction process presented here on the basis of an individually determined correction pressure with a pipetting duct 12 filled solely with working gas. Since the correction pressure can be determined at very high piston velocities, the improvement in the quality assessments can be achieved with only very small productivity losses.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention.

Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-15. (canceled)

16. A method for quality-assessed metering of a metering fluid by means of a pipetting device, where the pipetting device comprises:
a pipetting duct filled at least in part with a working gas,
a pipetting piston accommodated movably in the pipetting duct in order to modify a pressure of the working gas in the pipetting duct through a piston movement,
a pipetting aperture traversable by metering fluid in order to alter the quantity of fluid received in the pipetting duct,
a piston drive in order to drive the pipetting piston to a movement along the pipetting duct,
a pressure sensor in order to capture the pressure of the working gas in the pipetting duct,
a control device for storage and processing of data and for actuating the piston drive,
where the method comprises the following steps:
performing a metering process by moving the pipetting piston and thereby modifying the pressure of the working gas in the pipetting duct and thereby altering the quantity of metering fluid received in the pipetting duct,
capturing a temporal course of the pressure of the working gas in the pipetting duct during the metering process,
comparing a course of the working gas pressure on the basis of the captured temporal course of the working gas pressure with a specified pressure target values range, and
outputting a quality assessment of the metering process as a function of the result of the comparison step,
where the method further comprises the following further steps, where the control device performs the further steps while the pipetting duct is filled essentially solely with working gas as fluid:
performing a correction pressure determining process by moving the pipetting piston and thereby modifying the pressure of the working gas in the pipetting duct and thereby aspirating working gas into the pipetting duct and/or dispensing working gas out of the pipetting duct, and
capturing a pressure of the working gas in the pipetting duct during the correction pressure determining process as a correction pressure,
where the control device performs the following further step before the comparison step: correcting the temporal course of the working gas pressure captured during the metering process on the basis of the correction pressure of the working gas captured during the correction pressure determining process, such that the comparison step is performed with the corrected temporal course of the working gas pressure.

17. The method according to claim 16, wherein during the correction pressure determining process the pipetting piston is moved in the same direction of movement as during the metering process.

18. The method according to claim 17, wherein during the correction pressure determining process the pipetting piston is moved at a constant movement velocity and the correction pressure of the working gas is captured during the movement phase of constant movement velocity.

19. The method according to claim 16, wherein during the correction pressure determining process the pipetting piston is moved at a constant movement velocity and the correction pressure of the working gas is captured during the movement phase of constant movement velocity.

20. The method according to claim 16, wherein during the correction pressure determining process the pipetting piston is moved at a different velocity than during the metering process, where in a data memory there is recorded for a respective used type of the pipetting duct a data correlation which links different correction pressures with different piston velocities, where the control device determines, starting from the correction pressure actually captured at the piston velocity of the correction pressure determining process, on the basis of the data correlation, an expected correction pressure assigned to the piston velocity of the metering process and corrects the temporal course of the working gas pressure captured during the metering process by the expected correction pressure.

21. The method according to claim 16, wherein the piston velocity of the correction pressure determining process is higher than the piston velocity of the metering process.

22. The method according to claim 16, wherein the correction pressure is a differential pressure between the ambient pressure of the pipetting duct and the absolute pressure of the working gas in the pipetting duct.

23. The method according to claim 16, wherein the correction step comprises a decrease in terms of magnitude by the correction pressure of the temporal course of the working gas pressure captured during the metering process.

24. The method according to claim 16, wherein the pipetting duct exhibits a trunk duct with a coupling formation for temporary coupling of a pipetting tip, where the method exhibits the coupling of a pipetting tip to the trunk duct, where the correction pressure determining process is performed after the coupling of the pipetting tip.

25. The method according to claim 16, wherein the correction pressure determining process is performed before the metering process.

26. The method according to claim 16, wherein the control device corrects the temporal course of the working gas pressure captured during the metering process only up to the end of the movement of the pipetting piston.

27. The method according to claim 16, wherein the control device outputs a positive quality assessment if the comparison step yields that the course of the working gas pressure lies within a predefined section completely within the predetermined pressure target values range and/or that the control device outputs a negative quality assessment if the comparison step yields that the course of the working gas pressure lies within a predefined section outside the predetermined pressure target values range.

28. A pipetting device, comprising:
a pipetting duct filled at least in part with a working gas,
a pipetting piston accommodated movably in the pipetting duct in order to modify a pressure of the working gas in the pipetting duct through a piston movement,
a pipetting aperture traversable by metering fluid in order to alter the quantity of fluid received in the pipetting duct,
a piston drive in order to drive the pipetting piston to a movement along the pipetting duct,
a pressure sensor in order to capture the pressure of the working gas in the pipetting duct, and
a control device for storage and processing of data and for actuating the piston drive,
wherein the control device is designed for implementing the method according to claim 16.

29. The pipetting device according to claim 28, wherein the pipetting duct exhibits a trunk duct with a coupling formation for temporary coupling of a pipetting tip.

30. The pipetting device according to claim 29, wherein the pipetting device exhibits a pipetting tip coupleable to the coupling formation, where the pipetting tip exhibits for this purpose a counter-coupling formation complementary to the coupling formation.

31. The pipetting device according to claim 30, wherein the pipetting tip exhibits the pipetting aperture, where the pipetting tip exhibits a porous filter in a section between pipetting aperture and counter-coupling formation.
